(19) United States
(12) Patent Application Publication
(10) Pub. No.: US 2024/0152745 A1
(43) Pub. Date: May 9, 2024

(54) USING MACHINE LEARNING FOR CLASSIFYING PERSONALLY IDENTIFIABLE INFORMATION

(71) Applicant: Dell Products L.P., Round Rock, TX (US)

(72) Inventors: Bijan Kumar Mohanty, Austin, TX (US); Barun Pandey, Bangalore (IN); Shamik Kacker, Austin, TX (US); Hung Dinh, Austin, TX (US)

(21) Appl. No.: 17/980,895

(22) Filed: Nov. 4, 2022

(51) Int. Cl. G06N 3/08

(52) U.S. Cl. CPC G06N 3/08

(57) ABSTRACT

A method comprises receiving event-based data, extracting one or more attributes from the event-based data, and analyzing the one or more attributes to classify whether the one or more attributes comprise personally identifiable information. The analyzing is performed using one or more machine learning models. The event-based data corresponds to one or more events where the one or more attributes are added to at least one of a database and an application.

### FIELD

The field relates generally to information processing systems, and more particularly to using machine learning (ML) to classify personally identifiable information.

### BACKGROUND

Data privacy refers to a person's ability to determine for themselves when, how and to what extent personal information about them is shared with or communicated to others. Personally identifiable information (PII) can be, for example, one's name, location, contact information, government identification numbers, financial account numbers, etc. Websites, applications and social media platforms often need to collect and store personal data about users to provide services.

With the advent of (5th generation) 5G mobile networks and Internet of Things (IoT) devices, organizations are generating and consuming significant amounts of personal information. In order to adequately protect and implement appropriate controls for PII, quick and accurate identification of PII is needed.

### SUMMARY

Illustrative embodiments provide techniques to use machine learning to predict which types of information constitute PII.

In one embodiment, a method comprises receiving event-based data, extracting one or more attributes from the event-based data, and analyzing the one or more attributes to classify whether the one or more attributes comprise PII. The analyzing is performed using one or more machine learning models.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts details of an information processing system with a PII prediction platform for predicting whether information is PII according to an illustrative embodiment.

FIG. 2 depicts example PII information sources according to an illustrative embodiment.

FIG. 3 depicts an operational flow for PII prediction according to an illustrative embodiment.

FIG. 4 depicts an architecture of a neural network used for PII prediction according to an illustrative embodiment.

FIG. 5A depicts an example of a resource description framework (RDF) format for a relationship graph according to an illustrative embodiment.

FIG. 5B depicts an example of a labeled property graph (LPG) format for a relationship graph according to an illustrative embodiment.

FIG. 6 depicts a process for predicting whether information is PII according to an illustrative embodiment.

FIGS. 7 and 8 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous, and a user device receives messages without any significant time delay. Of course, it should be understood that depending on the particular temporal nature of the system in which an embodiment is implemented, other appropriate timescales that provide at least contemporaneous performance and output can be achieved.

As used herein, “personally identifiable information (PII)” refers to any information that can be used to distinguish or trace an individual's identity, such as, but not necessarily limited to, name, social security number, date and place of birth, mother's maiden name and/or biometric records, and any other information that is linked or linkable to an individual, such as, but not necessarily limited to, medical, educational, financial and/or employment information. See National Institute of Standards and Technology (NIST) Special Publication 800-122 (2010). Some other non-limiting examples of PII include, but are not necessarily limited to, financial transactions, medical history, criminal history, employment history, aliases, residential and mailing addresses, IP addresses, email addresses, online identifiers, passport number, driver's license number, telephone numbers, credit card numbers, vehicle registrations, x-rays, patient ID numbers, and biometric data (e.g., retina scan, voice signature, facial geometry, etc.).

There have been global, national and local treaties, legislation, regulations and/or other initiatives to protect PII. In general, the initiatives state that data corresponding to PII should be processed in a lawful, fair and transparent manner, be collected for specified, explicit and legitimate purposes, be adequate, relevant and limited to what is necessary in relation to the purpose for which the data is being processed (data minimization), be accurate, be maintained no longer than necessary and be processed in a manner that ensures appropriate security. Organizations may face significant penalties if they are not compliant with data privacy laws.

Illustrative embodiments provide technical solutions for the identification of PII data. Advantageously, the embodiments utilize an event driven mechanism to source PII data at the time of creation and/or updating of databases or applications. As an additional advantage, the illustrative embodiments leverage one or more machine learning models to identify in real-time whether data comprises PII and apply necessary protection and/or controls to safeguard the PII data. The PII data and metadata is stored in a centralized repository where the attributes represented by the data, metadata and their relationships can be maintained and queried. The embodiments can be especially useful in edge locations, where the quick identification of PII may be required.

In one or more embodiments, historical PII data is used to train a neural network-based machine learning classifier to identify PII from attributes added in applications and/or databases at a schema level. The embodiments leverage various enterprise data and/or metadata sources to identify PII data. The machine learning algorithms described herein enable accurate classification of PII data, making efficient use of compute resources and accelerating privacy operations at scale.

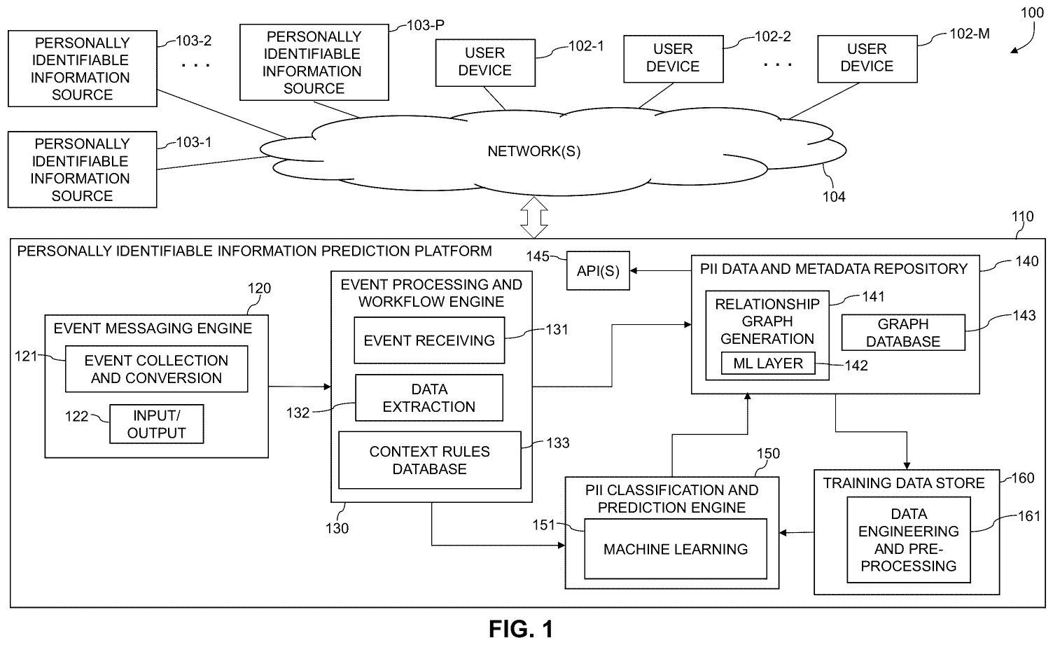

FIG. 1 shows an information processing system 100 configured in accordance with an illustrative embodiment. The information processing system 100 comprises user devices 102-1, 102-2, . . . 102-M (collectively “user devices 102”). The user devices 102 communicate over a network 104 with a PII prediction platform 110.

The user devices 102 can comprise, for example, Internet of Things (IoT) devices, desktop, laptop or tablet computers, mobile telephones, or other types of processing devices capable of communicating with the PII prediction platform 110 over the network 104. Such devices are examples of what are more generally referred to herein as “processing devices.” Some of these processing devices are also generally referred to herein as “computers.” The user devices 102 may also or alternately comprise virtualized computing resources, such as virtual machines (VMs), containers, etc. The user devices 102 in some embodiments comprise respective computers associated with a particular company, organization or other enterprise. The variable M and other similar index variables herein such as K, L and P are assumed to be arbitrary positive integers greater than or equal to one.

The terms “client,” “customer” or “user” herein are intended to be broadly construed so as to encompass numerous arrangements of human, hardware, software or firmware entities, as well as combinations of such entities. PII prediction services may be provided for users utilizing one or more machine learning models, although it is to be appreciated that other types of infrastructure arrangements could be used. At least a portion of the available services and functionalities provided by the PII prediction platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the PII prediction platform 110, as well as to support communication between the PII prediction platform 110 and connected devices (e.g., user devices 102) and/or other related systems and devices not explicitly shown.

In some embodiments, the user devices 102 are assumed to be associated with repair technicians, system administrators, information technology (IT) managers, software developers release management personnel or other authorized personnel configured to access and utilize the PII prediction platform 110.

The PII prediction platform 110 in the present embodiment is assumed to be accessible to the user devices 102, and vice-versa, over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The PII prediction platform 110, on behalf of respective infrastructure tenants each corresponding to one or more users associated with respective ones of the user devices 102, provides a platform for predicting whether information is PII.

Referring to FIG. 1, the PII prediction platform 110 comprises an event messaging engine 120, an event processing and workflow engine 130, a PII data and metadata repository 140, a PII classification and prediction engine 150 and a training data store 160. The event messaging engine 120 comprises an event collection and conversion component 121 and an input/output component 122. The event processing and workflow engine 130 comprises an event receiving component 131, a data extraction component 132 and a context rules database 133. The PII data and metadata repository 140 comprises a relationship graph generation component 141 comprising a machine learning (ML) layer 142, and a graph database 143. The PII data and metadata repository 140 is connected to one or more application programming interfaces (APIs) 145. The PII classification and prediction engine 150 comprises a machine learning (ML) layer 151. The training data store 160 comprises a data engineering and data pre-processing component 161.

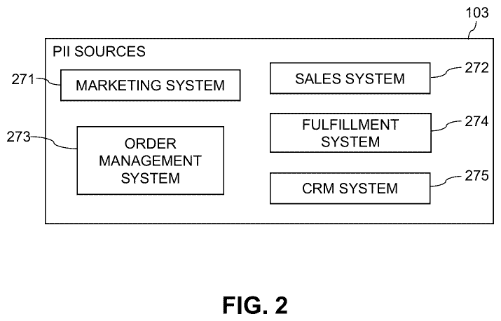

The event messaging engine 120 receives event-based data over network 104 from, for example, one or more PII sources 103-1, 103-2, . . . , 103-P (collectively “PII sources 103”). Referring to FIG. 2, in a non-limiting illustrative embodiment, the PII sources 103 comprise, for example, one or more of a marketing system 271, a sales system 272, an order management system 273, a fulfillment system 274 (e.g., supply chain) and a customer relationship management (CRM) system 275. The PII sources 103 comprise one or more databases and/or applications, where one or more attributes that may comprise PII may be added to or modified in the databases and/or applications. For example, the one or more attributes are modified in or added to database tables and/or object models of the applications. The addition or modification of the one or more attributes constitutes an event. Upon occurrence of an event, the event collection and conversion component 121 of the event messaging engine 120 receives an event message from one of the PII sources 103 comprising event-based data including, for example, the one or more attributes and corresponding information (e.g., metadata) about the parts of the databases and/or object models to which the attributes were added or in which the attributes were modified.

In illustrative embodiments, the event-based data comprises schema level information. The schema information includes, for example, a representation of the storage of data in a database, describing the organization or structure of data and the relationships between tables in a given database. In some embodiments, the schema information includes formatting for data entries, unique keys for entries and database objects, and the name and data type for each column and/or row in a table. A logical database schema provides details regarding how attributes from tables are linked together. Different schemas may use different syntax to define the logical architecture and constraints. In this case, the event collection and conversion component 121 is configured to convert the received data (e.g., event messages in different formats and/or with different syntaxes) into a standard (e.g., universal) format that can be processed by the remaining engines of the PII prediction platform 110. Some examples of schema information may include, but are not necessarily limited to, field formats for customer or user information (e.g., name, address, IDs, etc.), transaction information (e.g., customer IDs, transaction dates, etc.) and product information (e.g., products names, prices, etc.). Schema information can include, for example, primary keys uniquely identifying database table entries and foreign keys identifying primary keys from other tables. The schema information is parsed by the event collection and conversion component 121 to extract relevant information and put the relevant information into a format for further analysis.

Each of marketing system 271, sales system 272, order management system 273, fulfillment system 274 and CRM system 275 may include databases and/or applications comprising PII of customers, suppliers, distributors, contractors, employees, couriers, etc. For example, a CRM system 275 includes technical support personnel (e.g., agents) tasked with assisting users that experience issues with their devices, systems, software, firmware, etc. Users such as, for example, customers or clients, may contact the technical support personnel when they have device and/or system problems and require technical assistance to solve the problems. Customers or clients may communicate with the technical support personnel via the user devices 102. In response to customers, client or other user inquiries and/or requests for assistance, technical support personnel may create support tickets and/or cases summarizing the issues and the steps taken to resolve the issues. The support tickets and/or cases may include PII and other information that is entered into, for example, a database, thereby causing an event.

The event messaging engine 120 provides an interface layer for communications with the PII sources 103. Inbound or outbound communications involving multiple types of messages, pass through the event messaging engine 120 before and after being processed by the PII prediction platform 110. The input/output component 122 provides interfaces for PII sources 103 to access the PII prediction platform 110 and for user devices 102 to receive outputs from the PII prediction platform 110. The input/output component 122 further receives and processes incoming events from PII sources 103. For example, when a new attribute is added to a database table or object model, an event is triggered and an event message is automatically sent to the event messaging engine 120. At least a portion of the event messaging engine 120 may comprise a distributed event store and stream-processing platform such as, for example, Apache® Kafka ° available from the Apache Software Foundation of Wilmington, Delaware. The event messaging engine 120 provides a unified, high-throughput, low-latency platform for handling real-time data feeds.

As explained in more detail herein below, the input/output component 122 also receives and processes queries for PII directed to the PII data and metadata repository 140 from, for example, user devices 102 and/or the PII sources 103. The input/output component 122 receives and processes outgoing responses to the queries and causes transmission of the responses to the user devices 102 and/or the PII sources 103. The input/output component 122 comprises one or more APIs to interface with the different elements of the PII prediction platform 110, the user devices 102 and/or the PII sources 103. The input/output component 122 in combination with the event collection and conversion component 121 facilitates interactions between devices of multiple types (e.g., physical, virtual, mobile, desktop) through multiple mediums (e.g., web, cellular, satellite, etc.). For example, the input/output component 122 in combination with the event collection and conversion component 121 standardizes and formats communications based on different interface types.

The event receiving component 131 of the event processing and workflow engine 130 receives the processed event-data from the event messaging engine 120. The data extraction component 132 extracts relevant information required to perform PII classification as per context rules, which are stored in a context rules database 133. In more detail, attributes may depend on the context in which they are used. In a non-limiting illustrative example, an attribute referring to “state” in an order may indicate a status of the order, while an attribute referring to “state” in an address object may indicate a particular geographic region. The context rules identify which contexts to apply to various attributes depending on where the attribute is located an/or the type of data to which the attribute corresponds.

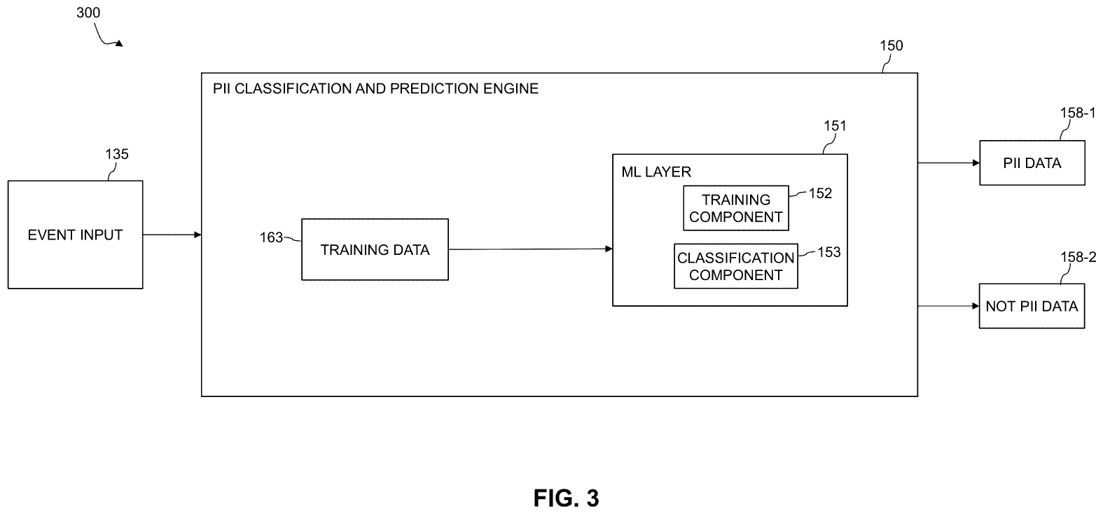

Referring to FIG. 1 and to the operational flow 300 in FIG. 3, the PII classification and prediction engine 150 includes a training component 152 and a classification component 153 in ML layer 151, which identifies whether an attribute comprises PII data by leveraging neural network-based classification algorithm as a binary classifier to predict the class (e.g., PII data or not PII data). The training component 152 utilizes existing PII data from the training data store 160 as training data 163. The training data 163 is input to the training component 152 of the ML layer 151 to train the machine learning model.

The training data store 160 includes historical data (e.g., historical enterprise data and/or historical data from other sources) with information such as whether an attribute is PII. The PII classification and prediction engine 150, more particularly, the training component 152, leverages supervised learning mechanisms, whereby the model is trained with the historical data labelled with an indicator of whether data is PII. Some of the features that influence the target variables (e.g., PII data or not PII data) and which are extracted from the training dataset include, for example, attribute name, parent attribute(s) and related attribute(s). During the training, these features are fed into the model as independent variables and the values of the class (attribute is PII or not PII) are fed into the model as the dependent/target values. On receiving a new event input 135, the trained classifier-based model is used to predict if one or more attributes from the event input 135 are PII data 158-1 or not PII data 158-2.

Referring to FIG. 1, the training data store 160 includes a data engineering and data pre-processing component 161, which according to an embodiment, performs data engineering and data pre-processing to identify the features and the data elements that will be influencing the PII data predictions. In illustrative embodiments, the data engineering and data pre-processing includes generating multivariate plots and correlation heatmaps to identify the significance of each feature in a training dataset, and filter less important data elements. The data engineering and data pre-processing reduces the dimensions and complexity of the model, hence improving the accuracy and performance of the model. In some embodiments, the data engineering and data pre-processing component 161 cleans any unwanted characters and stop words from the training data, and may perform stemming and lemmatization, as well as changing text to lower case, removing punctuation, and removing incorrect or unnecessary characters. Once the data is ready to be used as training data 163, the training data 163 is input to the training component of the ML layer 151.

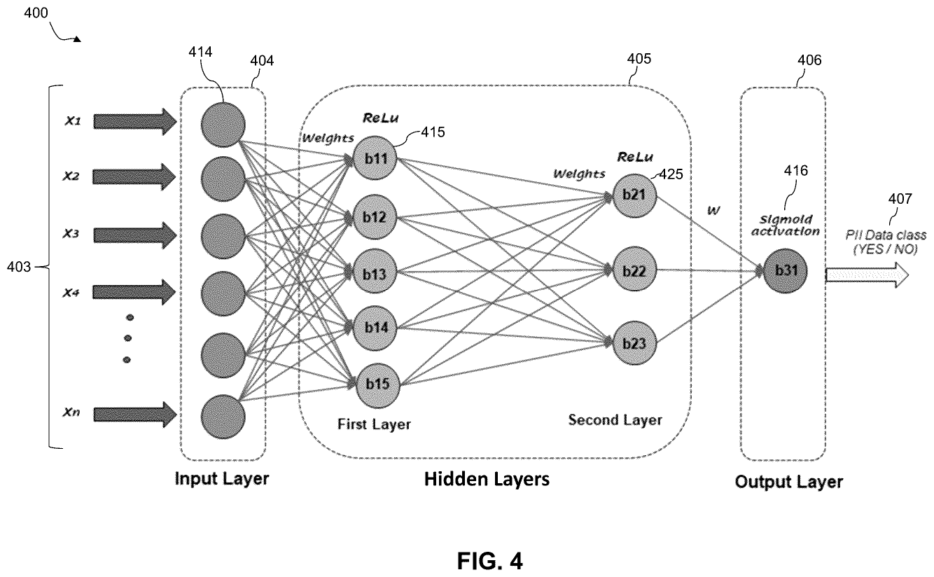

Referring to FIG. 4, extracted attributes 403 from the event processing and workflow engine 130 are input to an input layer 404 of neural network 400 comprising at least two hidden layers 405 (e.g., first and second layers) and an output layer 406. The neural network 400 is an element of the classification component 153, which predicts whether an attribute comprises PII data. The extracted attributes 403 include, but are not necessarily limited to, features or elements added to databases or applications of the various PII sources 103 (e.g., marketing system 271, sales system 272, order management system 273, fulfillment system 274 and CRM system 275) that may include one or more of the types of the PII described herein.

During the training, the features noted herein above (e.g., extracted attributes 403) are input to the neural network (or other machine learning model) as independent variables with the values of the class (attribute is PII or not PII) in the dataset as dependent (e.g., target values). Once trained the machine learning model predicts the values of the class (attribute is PII or not PII).

Referring to FIG. 4, the neural network 400 comprises, for example, a deep neural network comprising an input layer 404, one or more hidden layers 405 and an output layer 406. Input layer 404 comprises a plurality of neurons 414 (nodes) that matches the number of input independent variables (e.g., features). Hidden layers 405 comprise first and second layers. The number of neurons 415 and 425 in each of the first and second layers depend on the number of neurons 414 in the input layer 404. As the machine learning model is a binary classification model, the output layer 406 includes a single neuron 416 corresponding to a YES or NO output 407 (YES-PII data, NO—not PII data).

Although there are five neurons/nodes 415 shown in the first layer of the hidden layers 405 and three neurons/nodes 425 shown in the second layer of the hidden layers 405, the actual number of neurons 415 and 425 depend on the total number of neurons 414 in the input layer 404. For example, the number of neurons 415 in the first layer is calculated based on an algorithm matching the power of 2 to the number of input neurons 414. For example, in a non-limiting illustrative example, if the number of input variables is 19, the number of neurons in the first layer of the hidden layers 405 is 2⁵, which is equal to 32. 2⁴, which is equal to 16, is too small (e.g., less than 19). As a result, the first layer of the hidden layers 405 will have 2⁵⁼³² neurons, and the second layer of the hidden layers 405 will include 2⁴⁼¹⁶ neurons. If there were a third hidden layer, it would include 2³⁼⁸ neurons. The embodiments are not necessarily limited to basing the number of neurons 415 and 425 in the hidden layers 405 on the number neurons 414 in the input layer 404, and other methods to determine the number of neurons 415 and 425 may be used.

According to illustrative embodiments, the neurons 415 and 425 in the hidden layers 405 and the neurons 416 in the output layer 406 utilize an activation function which determines whether the neuron will fire or not fire. For example, rectified linear unit (ReLu) activation function is used for the neurons 415 and 425 in both the first and second ones of the hidden layers 405. Considering the model is configured to function as a binary classifier, the output neuron 416 in the output layer 406 utilizes a Sigmoid activation function. The embodiments are not necessarily limited to the ReLu and Sigmoid activation functions.

In the illustrative embodiment of FIG. 4, each of the neurons 414 connects with each of the neurons 415, each of the neurons 415 connects with each of the neurons 425 and each of the neurons 425 connects with the neuron 416. Each connection has a weight factor and each of the neurons 415, 425 and 416 has a bias factor. In an illustrative embodiment, the weight and bias values may be randomly set by the neural network 400, and may start at values of 1 or 0. In illustrative embodiments, each neuron 415 computes a weighted sum (WS) by adding the products of each input variable (X1, X2, X3, X4, . . . , Xn) with their weight factors and then adding the bias of the neuron 415. The formula for this calculation is shown as equation (1) below.

WSz=(X1)(W1z)+(X2)(W2z)+(X3)(W3z)+(X4)(W4z), . . . ,(Xn)(Wnz)+b1z (1)

where WSz is the weighted sum of neuron Z, where Z is from 1 (for the 1^{st} neuron 415) to the number of neurons 415 in the first layer of the hidden layers 405. X1, X2, etc. are the input values to the model and W1z, W2z, etc. are the weight values applied to the connections to the neuron Z from the input neurons 414 and b1z is the bias value of neuron Z. This weighted sum WSz is input to an activation function (e.g., in this case ReLu) to compute the value of the activation function for each neuron 415. The weighted sum values of all neurons 415 in the first layer are calculated in accordance with equation (1).

In illustrative embodiments, each neuron 425 computes a next weighted sum (NWS) by adding the products of each weighted sum from the neurons 415 (WS1, WS2, WS3, WS4, . . . , WSz) with their weight factors and then adding the bias of the neuron 425. The formula for this calculation is shown as equation (2) below.

NWSy=(WS1)(W1y)+(WS2)(W2y)+(WS3)(W3y)+(WS4)(W4y), . . . ,(WSz)(Wzy)+b2y (2)

where NWSy is the weighted sum of neuron Y, where Y is from 1 (for the 1^{st} neuron 425) to the number of neurons 425 in the second layer of the hidden layers 405. WS1, WS2, etc. are the weighted sums from the neurons 415 and W1y, W2y, etc. are the weight values applied to the connections to the neuron Y from the neurons 415 and b2y is the bias value of neuron Y. This next weighted sum NWSy is input to an activation function (e.g., in this case ReLu) to compute the value of the activation function for each neuron 425. The next weighted sum values of all neurons 425 in the second layer are calculated in accordance with equation (2).

In illustrative embodiments, the neuron 416 computes a final weighted sum (FWS) by adding the products of each next weighted sum from the neurons 425 (NWS1, NWS2, . . . , NWSy) with their weight factors and then adding the bias of the neuron 416. The formula for this calculation is shown as equation (3) below.

FWS=(NWS1)(W1)+(NWS2)(W2), . . . ,(NWSy)(Wy)+b3 (3)

where FWS is the weighted sum of neuron 416 in the output layer 406. NWS1, NWS2, etc. are the next weighted sums from the neurons 425 and W1, W2, etc. are the weight values applied to the connections to the neuron 416 from the neurons 425 and b3 is the bias value of neuron 416. This final weighted sum FWS is input to an activation function (e.g., in this case Sigmoid) to compute the value of the activation function for the neuron 416. The final weighted sum value of neuron 416 in the output layer 406 is calculated in accordance with equation (3).

The final weighted sum value is compared to a target value. Depending upon the difference from the target value, a loss value is calculated. The pass through of the neural network 400 is a forward propagation, which calculates error and drives a backpropagation through the neural network 400 to minimize the loss (e.g., error) at each neuron 414, 415, 425 and 416 of the neural network 400. Considering loss may be generated by all the neurons 414, 415, 425 and 416 in the neural network 400, a backpropagation process goes through each layer from the output layer 406 to the input layer 404 and attempts to minimize the loss by using a gradient descent-based optimization mechanism. Considering the neural network 400 is used in illustrative embodiments as a binary classifier, illustrative embodiments use “binary crossentropy” as a loss function, adam (adaptive moment estimation) or “RMSProp” as an optimization algorithm, and “accuracy” as a metrics value.

The result of the backpropagation processing is to adjust the weight and/or bias values corresponding to one or more connections and/or neurons 414, 415, 425 and 416 in order to reduce loss. Once all the observations of the training data are passed through the neural network 400, an epoch is completed. Another forward propagation is initiated with the adjusted weight and bias values, which is considered as epoch2. The same process of forward and backpropagation is repeated in subsequent epochs. This process of repeating the epochs results in the reduction of loss to a relatively small number (e.g., close to 0), at which point the neural network 400 is considered to be sufficiently trained for prediction.

Once PII classification is successfully performed on a new event, the classification is stored in the PII data and metadata repository 140 along with the relationships and other elements and/or attributes for governance and queries. The PII data and metadata repository 140 stores and manages PII data elements and their relationships to other elements in a central manner for scalability, high performance and fast access to the data. The other elements may include, for example, other attributes that include PII or do not include PII. For example, the PII data and metadata repository 140 can store related PII, such as different types of PII for the same person, or PII related by category (e.g., medical PII, financial PII, etc.). In addition, PII data may be related to other data that is not PII. For example, customers and their PII may be associated with particular order, marketing or supply chain information that is not PII. In one or more illustrative embodiments, a graph database is leveraged to manage PII data elements and their relationships. In other embodiments, a no-SQL database can be used.

The PII data and metadata repository 140 comprises a relationship graph generation component 141, which includes an ML layer 142 that uses one or more machine learning techniques to build relationship graphs corresponding to PII data elements and their relationships to other elements. The PII data and metadata repository 140 stores the relationship graphs in a graph database 143 to provide a knowledge base of PII for an enterprise or other entity.

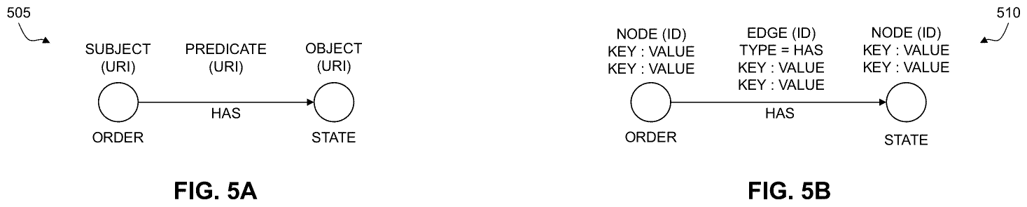

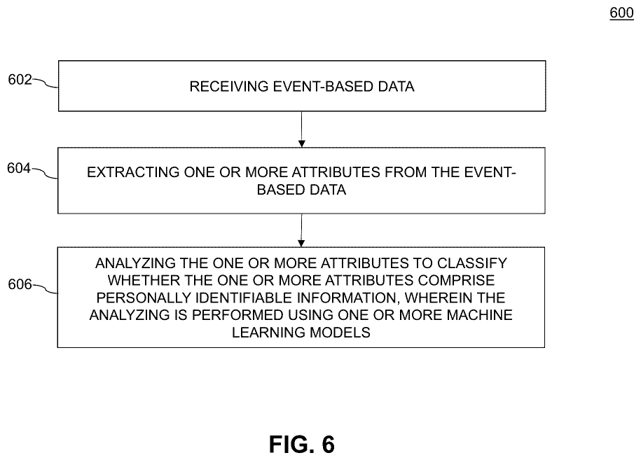

Referring to FIGS. 5A and 5B, examples of a resource description framework (RDF) format 505 and a labeled property graph (LPG) format 510 for a relationship graph are shown. In accordance with embodiments, the RDF format or the LPG format can be used for storing information on and retrieving information from relationship graphs. The examples of the RDF and LPG formats are explained in terms of an order having a state, but the embodiments are not limited thereto.

The RDF format 505 structures information (e.g., entities and relationship) as a triple comprising a subject, predicate and object. For example, an order that has a state is stored as a subject (order), the predicate is the relationship (e.g., has) and the object is the other entity (e.g., state). As can be seen, the subject is a node/entity in the graph. The predicate is an edge (e.g., relationship between nodes), and the object is another node. These nodes and edges are identified by unique identifiers (URIs), which are used to label the nodes and edges.

With the LPG format 510, each entity is represented as a node with a uniquely identifiable ID and a set of key-value pairs corresponding to properties that characterize the entity (e.g., in this case key-value pairs that identify the order and the attribute (state)). The relationship between two entities comprises an edge, which is a connection between the nodes. Relationships are uniquely identified by a uniquely identifiable ID and a type (e.g., has). Relationships are also represented by a set of key-value pairs corresponding to properties that characterize the connections. While two key-value pairs are shown as corresponding to each entity and relationship, the embodiments are not necessarily limited thereto, and more or less than two key-value pairs may be used to identify and characterize the nodes and edges.

According to one or more embodiments, the PII data and metadata repository 140 stores relationship graphs in the graph database 143 and provides relationship data from the relationship graphs in response to queries or other inputs. The graphical format permits data analysis and traversal at multiple levels in real-time and enables the real-time addition of new context and connections. Advantageously, the graph-based PII data and metadata repository 140 provides a foundation for maintaining data of an enterprise, which accelerates the growth and sustenance of long-term knowledge. The PII data and metadata repository 140 is capable of being enriched with raw and derived data over time, resulting in graphs that include increasing levels of details, context, truth, intelligence, and semantics. The graphical format is more indicative of a user's real-world ecosystem and domain than other representations of data, and provides a more efficient mechanism for search and retrieval of information than other approaches. Data can be retrieved from the PII data and metadata repository 140 using a variety of query languages capable of traversing graphs such as, but not necessarily limited to, formats including structured query language (SQL) and SPARQL. Some non-limiting examples of graph traversal languages that may be used with the PII data and metadata repository 140 include Gremlin, Cypher, GraphQL and/or Graphene. GraphQL and Graphene are languages for APIs (e.g., API(s) 145) to access the data in the graph database 143.

Given a particular event, the PII classification and prediction engine 150 uses one or more machine learning techniques to identify secure and private data in real-time at the time of data element creation in any application and/or database. Leveraging a sophisticated binary classification machine learning model to predict whether attributes comprise PII as a real-time response to attribute creation, the embodiments support the efficient implementation of security and governance measures for the corresponding PII data. In some embodiments, the PII prediction platform 110 performs other automated actions based on the classification including, but not necessarily limited to, automatically implementing security and/or access restrictions for the PII based on the classification, automatically generating and transmitting alerts and/or notifications regarding PII classifications and/or recommended actions based on the PII classifications to one of the user devices 102, and/or automatically uploading code, firmware, upgrades and/or other applications and software to the user devices 102 to security and/or access restrictions for the PII.

According to one or more embodiments, one or more of the databases (e.g., context rules database 133, graph database 143, training data store 160) and/or repositories (e.g., PII data and metadata repository 140) used by the PII prediction platform 110 can be configured according to a relational database management system (RDBMS) (e.g., PostgreSQL). Databases and/or repositories in some embodiments are implemented using one or more storage systems or devices associated with the PII prediction platform 110. In some embodiments, one or more of the storage systems utilized to implement the databases comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the PII prediction platform 110, the event messaging engine 120, the event processing and workflow engine 130, the PII data and metadata repository 140, the PII classification and prediction engine 150 and the training data store 160 in other embodiments can be implemented at least in part externally to the PII prediction platform 110, for example, as stand-alone servers, sets of servers or other types of systems coupled to the network 104. For example, the event messaging engine 120, the event processing and workflow engine 130, the PII data and metadata repository 140, the PII classification and prediction engine 150 and the training data store 160 may be provided as cloud services accessible by the PII prediction platform 110.

The event messaging engine 120, the event processing and workflow engine 130, the PII data and metadata repository 140, the PII classification and prediction engine 150 and the training data store 160 in the FIG. 1 embodiment are each assumed to be implemented using at least one processing device. Each such processing device generally comprises at least one processor and an associated memory, and implements one or more functional modules for controlling certain features of the event messaging engine 120, the event processing and workflow engine 130, the PII data and metadata repository 140, the PII classification and prediction engine 150 and/or the training data store 160.

At least portions of the PII prediction platform 110 and the components thereof may be implemented at least in part in the form of software that is stored in memory and executed by a processor. The PII prediction platform 110 and the components thereof comprise further hardware and software required for running the PII prediction platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the event messaging engine 120, the event processing and workflow engine 130, the PII data and metadata repository 140, the PII classification and prediction engine 150, the training data store 160 and other components of the PII prediction platform 110 in the present embodiment are shown as part of the PII prediction platform 110, at least a portion of the event messaging engine 120, the event processing and workflow engine 130, the PII data and metadata repository 140, the PII classification and prediction engine 150, the training data store 160 and other components of the PII prediction platform 110 in other embodiments may be implemented on one or more other processing platforms that are accessible to the PII prediction platform 110 over one or more networks. Such components can each be implemented at least in part within another system element or at least in part utilizing one or more stand-alone components coupled to the network 104.

It is assumed that the PII prediction platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the event messaging engine 120, the event processing and workflow engine 130, the PII data and metadata repository 140, the PII classification and prediction engine 150, the training data store 160 and other components of the PII prediction platform 110, and the elements thereof can each be implemented in the form of one or more LXCs running on one or more VMs. Other arrangements of one or more processing devices of a processing platform can be used to implement the event messaging engine 120, the event processing and workflow engine 130, the PII data and metadata repository 140, the PII classification and prediction engine 150 and the training data store 160, as well as other components of the PII prediction platform 110. Other portions of the system 100 can similarly be implemented using one or more processing devices of at least one processing platform.

Distributed implementations of the system 100 are possible, in which certain components of the system reside in one datacenter in a first geographic location while other components of the system reside in one or more other data centers in one or more other geographic locations that are potentially remote from the first geographic location. Thus, it is possible in some implementations of the system 100 for different portions of the PII prediction platform 110 to reside in different data centers. Numerous other distributed implementations of the PII prediction platform 110 are possible.

Accordingly, one or each of the event messaging engine 120, the event processing and workflow engine 130, the PII data and metadata repository 140, the PII classification and prediction engine 150, the training data store 160 and other components of the PII prediction platform 110 can each be implemented in a distributed manner so as to comprise a plurality of distributed components implemented on respective ones of a plurality of compute nodes of the PII prediction platform 110.

It is to be appreciated that these and other features of illustrative embodiments are presented by way of example only and should not be construed as limiting in any way.

Accordingly, different numbers, types and arrangements of system components such as the event messaging engine 120, the event processing and workflow engine 130, the PII data and metadata repository 140, the PII classification and prediction engine 150, the training data store 160 and other components of the PII prediction platform 110, and the elements thereof can be used in other embodiments.

It should be understood that the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

For example, as indicated previously, in some illustrative embodiments, functionality for the PII prediction platform can be offered to cloud infrastructure customers or other users as part of FaaS, CaaS and/or PaaS offerings.

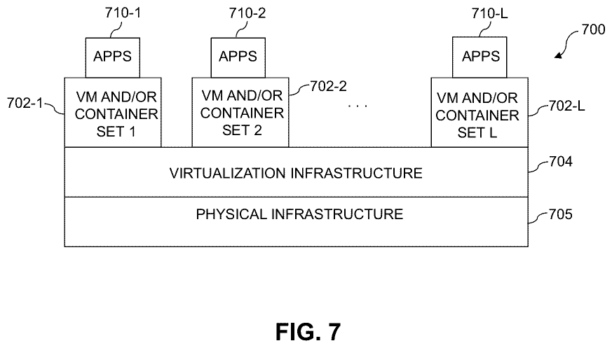

The operation of the information processing system 100 will now be described in further detail with reference to the flow diagram of FIG. 6. With reference to FIG. 6, a process 600 for predicting whether information is PII as shown includes steps 602 through 606, and is suitable for use in the system 100 but is more generally applicable to other types of information processing systems comprising a PII prediction platform configured for predicting whether information is PII.

In step 602, event-based data is received. The event-based data corresponds to one or more events where one or more attributes are added to at least one of a database and an application. For example, the one or more attributes are added to at least one of a table of the database and an object model of the application. In illustrative embodiments, the event-based data comprises schema level information.

In step 604, the one or more attributes are extracted from the event-based data. The extracting of the one or more attributes from the event-based data may be based at least in part on one or more context rules.

In step 606, the one or more attributes are analyzed to classify whether the one or more attributes comprise PII. The analyzing is performed using one or more machine learning models, and can be performed in real-time responsive to the one or more events.

The one or more machine learning models comprise a neural network-based binary classification algorithm to classify whether the one or more attributes comprise PII. A neural network of the neural network-based binary classification algorithm is trained with training data comprising a plurality of attributes as independent variables, wherein respective ones of the plurality of attributes correspond to respective dependent variables indicating whether the respective ones of the plurality of attributes comprise PII. In illustrative embodiments, the neural network comprises at least two hidden layers utilizing a ReLu activation function, and plurality of nodes connected with each other. Respective ones of the connections comprise a weight factor and respective ones of the plurality of nodes comprise a bias factor.

The one or more attributes that have been classified as comprising PII are stored in one or more relationship graphs. The one or more relationship graphs comprise a plurality of relationships between a plurality of nodes, wherein the plurality of relationships comprise edges of the one or more relationship graphs. The plurality of nodes comprise the one or more attributes that have been classified as comprising PII and one or more other attributes. The one or more other attributes may include, for example, other attributes that include PII or do not include PII. The plurality of relationships comprise interactions between respective pairs of the plurality of nodes. The one or more relationship graphs are in one of an RDF format and an LPG format.

It is to be appreciated that the FIG. 6 process and other features and functionality described above can be adapted for use with other types of information systems configured to execute PII prediction services in a PII prediction platform or other type of platform.

The particular processing operations and other system functionality described in conjunction with the flow diagram of FIG. 6 is therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 6 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a PII prediction platform as disclosed herein can provide a number of significant advantages relative to conventional arrangements. For example, unlike conventional techniques, the embodiments provide technical solutions with functionality for managing PII data across one or more enterprises by utilizing an event driven mechanism to source attributes at the time of their creation and/or updating in databases and/or applications. Illustrative embodiments advantageously leverage machine learning to identify whether these attributes are PII, and then store the identified PII attributes in a centralized repository where the attributes and their relationships are able to be maintained and queried. For example, the PII prediction platform advantageously builds a PII data and metadata repository utilizing graphical techniques to store and manage PII data elements and their relationships with other elements and attributes for efficient traversals and query execution.

As an additional advantage, unlike conventional approaches, which are reactive in nature and use vast amounts of compute resources to map data at column and cell levels of database, the embodiments use a neural network-based binary classification algorithm to proactively predict as a real-time response to data attribute creation or updating whether data elements constitute PII.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system components such as the PII prediction platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a PII prediction platform in illustrative embodiments. These and other cloud-based systems in illustrative embodiments can include object stores.

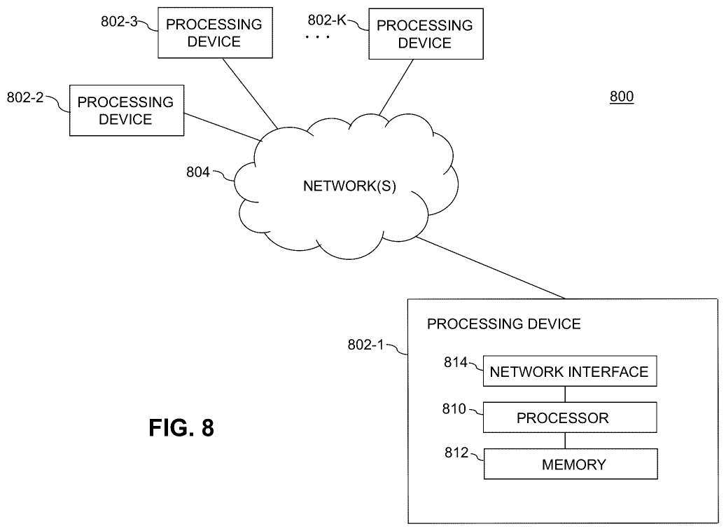

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812. The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more components of the PII prediction platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and PII prediction platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
receiving event-based data;
extracting one or more attributes from the event-based data; and
analyzing the one or more attributes to classify whether the one or more attributes comprise personally identifiable information, wherein the analyzing is performed using one or more machine learning models;
wherein the steps of the method are executed by a processing device operatively coupled to a memory.

2. The method of claim 1, wherein the event-based data corresponds to one or more events where the one or more attributes are added to at least one of a database and an application.

3. The method of claim 2, wherein the one or more attributes are added to at least one of a table of the database and an object model of the application.

4. The method of claim 2, wherein the analyzing is performed in real-time responsive to the one or more events.

5. The method of claim 1, wherein the event-based data comprises schema level information.

6. The method of claim 1, wherein the extracting of the one or more attributes from the event-based data is based at least in part on one or more context rules.

7. The method of claim 1, wherein the one or more machine learning models comprise a neural network-based binary classification algorithm to classify whether the one or more attributes comprise personally identifiable information.

8. The method of claim 7, further comprising training a neural network of the neural network-based binary classification algorithm with training data comprising a plurality of attributes as independent variables, wherein respective ones of the plurality of attributes correspond to respective dependent variables indicating whether the respective ones of the plurality of attributes comprise personally identifiable information.

9. The method of claim 7, wherein a neural network of the neural network-based binary classification algorithm comprises at least two hidden layers utilizing a rectified linear unit activation function.

10. The method of claim 7, wherein a neural network of the neural network-based binary classification algorithm comprises a plurality of nodes connected with each other, and wherein respective ones of the connections comprise a weight factor and respective ones of the plurality of nodes comprise a bias factor.

11. The method of claim 1, further comprising storing, in one or more relationship graphs, the one or more attributes that have been classified as comprising personally identifiable information, wherein the one or more relationship graphs comprise a plurality of relationships between a plurality of nodes, wherein the plurality of relationships comprise edges of the one or more relationship graphs.

12. The method of claim 11, wherein the plurality of nodes comprise the one or more attributes that have been classified as comprising personally identifiable information and one or more other attributes.

13. The method of claim 11, wherein the plurality of relationships comprise interactions between respective pairs of the plurality of nodes.

14. The method of claim 11, wherein the one or more relationship graphs are in one of a resource description framework (RDF) format and a labeled property graph (LPG) format.

15. An apparatus, comprising:
a processing device operatively coupled to a memory and configured to:
receive event-based data;
extract one or more attributes from the event-based data; and
analyze the one or more attributes to classify whether the one or more attributes comprise personally identifiable information, wherein the analyzing is performed using one or more machine learning models.

16. The apparatus of claim 15, wherein the one or more machine learning models comprise a neural network-based binary classification algorithm to classify whether the one or more attributes comprise personally identifiable information.

17. The apparatus of claim 16, wherein the processing device is further configured to train a neural network of the neural network-based binary classification algorithm with training data comprising a plurality of attributes as independent variables, wherein respective ones of the plurality of attributes correspond to respective dependent variables indicating whether the respective ones of the plurality of attributes comprise personally identifiable information.

18. An article of manufacture comprising a non-transitory processor-readable storage medium having stored therein program code of one or more software programs, wherein the program code when executed by at least one processing device causes said at least one processing device to perform the steps of:
receiving event-based data;
extracting one or more attributes from the event-based data; and
analyzing the one or more attributes to classify whether the one or more attributes comprise personally identifiable information, wherein the analyzing is performed using one or more machine learning models.

19. The article of manufacture of claim 18, wherein the one or more machine learning models comprise a neural network-based binary classification algorithm to classify whether the one or more attributes comprise personally identifiable information.

20. The article of manufacture of claim 19 wherein the program code further causes said at least one processing device to perform the step of training a neural network of the neural network-based binary classification algorithm with training data comprising a plurality of attributes as independent variables, wherein respective ones of the plurality of attributes correspond to respective dependent variables indicating whether the respective ones of the plurality of attributes comprise personally identifiable information.
